(19) United States
(12) Patent Application Publication
(10) Pub. No.: US 2020/0250971 A1
(43) Pub. Date: Aug. 6, 2020

(54) VEHICLE CAPSULE NETWORKS

(71) Applicant: Ford Global Technologies, LLC, Dearborn, MI (US)

(72) Inventors: Zhen Zhao, Farmington Hills, MI (US); KP Unnikrishnan, Ann Arbor, MI (US); Ashley Naomi Kleinhans, Highland, MI (US); Gursharan Sandhu, Royal Oak, MI (US); Ishan Patel, Ann Arbor, MI (US); Bryan Roger Goodman, Northville, MI (US)

(73) Assignee: Ford Global Technologies, LLC, Dearborn, MI (US)

(21) Appl. No.: 16/268,697

(22) Filed: Feb. 6, 2019

(51) Int. Cl. G08G 1/04; G06K 9/00; G08G 5/00; G06K 9/62; G05D 1/02

(52) U.S. Cl. CPC G08G 1/04; G06K 9/00664; G08G 5/0078; G08G 1/096725; G06K 9/6268; G05D 1/0276; G06K 2209/21; G06K 9/6256

(57) ABSTRACT

A system, comprising a computer that includes a processor and a memory, the memory storing instructions executable by the processor to detect, classify and locate an object by processing video camera data with a capsule network, wherein training the capsule network includes saving routing coefficients. The computer can be further programmed to receive the detected, classified, and located object.

### BACKGROUND

Vehicles can be equipped to operate in both autonomous and occupant piloted mode. Vehicles can be equipped with computing devices, networks, sensors and controllers to acquire information regarding the vehicle's environment and to operate the vehicle based on the information. Safe and comfortable operation of the vehicle can depend upon acquiring accurate and timely information regarding the vehicle's environment. Vehicle sensors can provide data concerning routes to be traveled and objects to be avoided in the vehicle's environment. Safe and efficient operation of the vehicle can depend upon acquiring accurate and timely information regarding routes and objects in a vehicle's environment while the vehicle is being operated on a roadway.

### BRIEF DESCRIPTION OF THE DRAWINGS

FIG. 1 is a block diagram of an example traffic infrastructure system.

FIG. 2 is a diagram of an example traffic scene with a stationary camera.

FIG. 3 is a diagram of an example capsule network.

FIG. 4 is a flowchart diagram of an example routing algorithm.

FIG. 5 is a diagram of example master routing coefficient matrices.

FIG. 6 is another diagram of example master routing coefficient matrices.

FIG. 7 is another diagram of example master routing coefficient matrices.

FIG. 8 is a flowchart diagram of a process to determine object positions and download them to a vehicle.

### DETAILED DESCRIPTION

Vehicles can be equipped to operate in both autonomous and occupant piloted mode. By a semi- or fully-autonomous mode, we mean a mode of operation wherein a vehicle can be piloted partly or entirely by a computing device as part of an information system having sensors and controllers. The vehicle can be occupied or unoccupied, but in either case the vehicle can be partly or completely piloted without assistance of an occupant. For purposes of this disclosure, an autonomous mode is defined as one in which each of vehicle propulsion (e.g., via a powertrain including an internal combustion engine and/or electric motor), braking, and steering are controlled by one or more vehicle computers; in a semi-autonomous mode the vehicle computer(s) control(s) one or two of vehicle propulsion, braking, and steering. In a non-autonomous vehicle, none of these are controlled by a computer.

A computing device in a vehicle can be programmed to acquire information regarding the external environment of a vehicle and to use the information to determine a vehicle's path upon which to operate a vehicle based on a vehicle's path in autonomous or semi-autonomous mode. A vehicle's path is a straight or curved line that describes successive locations (i.e., locations at different times) of a vehicle on a two-dimensional (2D) plane parallel to the surface of a roadway upon which the vehicle operates. A vehicle can operate on a roadway based on a vehicle's path by determining commands to direct the vehicle's powertrain, braking, and steering components to operate a vehicle so as to move along the path. The information regarding the external environment can include the location of a tracked object in global coordinates. An example tracked object can be another vehicle. The information can be received from a traffic information system and can be based on processing stationary video camera data with a capsule network.

Disclosed herein is a method, including detecting, classifying and locating an object by processing video camera data with a capsule network, wherein training the capsule network includes saving routing coefficients and receiving the detected, classified and located object at a computing device. The capsule network can include a neural network wherein data aggregation between capsule layers is based on determining routing coefficients corresponding to routes between capsule layers. Routing coefficients can be determined by grouping routes based on one or more of correlation or clustering following training based on a first training data set, wherein a route connects determined elements in a capsule layer with locations in a subsequent capsule layer. Routing coefficients can be determined by parallel array processing.

Training the capsule network can include re-training the capsule network based on a second training data set and saved routing coefficients. A vehicle can be operated based on receiving a detected, classified, and located object. Operating a vehicle can be based on receiving a detected, classified, and located object included determining a predicted location of the object in global coordinates. Traffic information can be based on receiving a detected, classified and located object. The video camera data can be acquired with one or more of a stationary video camera included in a traffic infrastructure system and a mobile video camera included in one or more of a vehicle and a drone. A location of the vehicle and a location of the object can be measured in global coordinates. The global coordinates can be latitude, longitude, and altitude. The vehicle can be operated based on the detected, classified, and located object. Operating the vehicle can include controlling one or more of vehicle powertrain, vehicle steering, and vehicle brakes. Operating the vehicle can include determining a vehicle path.

Further disclosed is a computer readable medium, storing program instructions for executing some or all of the above method steps. Further disclosed is a computer programmed for executing some or all of the above method steps, including a computer apparatus, programmed to detect, classify, and locate an object by processing video camera data with a capsule network, wherein training the capsule network includes saving routing coefficients and receive the detected, classified and located object at a computing device. The capsule network can include a neural network wherein data aggregation between capsule layers is based on determining routing coefficients corresponding to routes between capsule layers. Routing coefficients can be determined by grouping routes based on one or more of correlation or clustering following training based on a first training data set, wherein a route connects determined elements in a capsule layer with locations in a subsequent capsule layer. Routing coefficients can be determined by parallel array processing.

The computer apparatus can be further programed to train the capsule network including re-training the capsule network based on a second training data set and saved routing coefficients. A vehicle can be operated based on receiving a detected, classified, and located object. Operating a vehicle can be based on receiving a detected, classified, and located object included determining a predicted location of the object in global coordinates. Traffic information can be based on receiving a detected, classified and located object. The video camera data can be acquired with one or more of a stationary video camera included in a traffic infrastructure system and a mobile video camera included in one or more of a vehicle and a drone. A location of the vehicle and a location of the object can be measured in global coordinates. The global coordinates can be latitude, longitude, and altitude. The vehicle can be operated based on the detected, classified, and located object. Operating the vehicle can include controlling one or more of vehicle powertrain, vehicle steering, and vehicle brakes. Operating the vehicle can include determining a vehicle path.

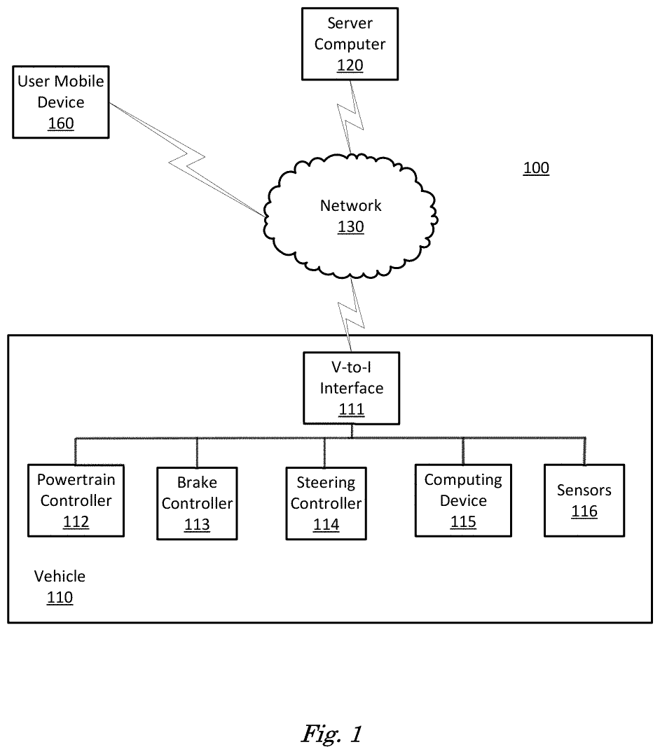

FIG. 1 is a diagram of a traffic infrastructure system 100 that includes a vehicle 110 operable in autonomous (“autonomous” by itself in this disclosure means “fully autonomous”), semi-autonomous, and occupant piloted (also referred to as non-autonomous) mode. One or more vehicle 110 computing devices 115 can receive information regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network, e.g., including a bus in the vehicle 110 such as a controller area network (CAN) or the like; the vehicle 110 network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, includes hardware, firmware, and software that permits computing device 115 to communicate with a remote server computer 120 via a network 130 such as wireless Internet (Wi-Fi) or cellular networks. V-to-I interface 111 may accordingly include processors, memory, transceivers, etc., configured to utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks, e.g., according to Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log information by storing the information in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executable by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve safe and efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computer 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, e.g., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

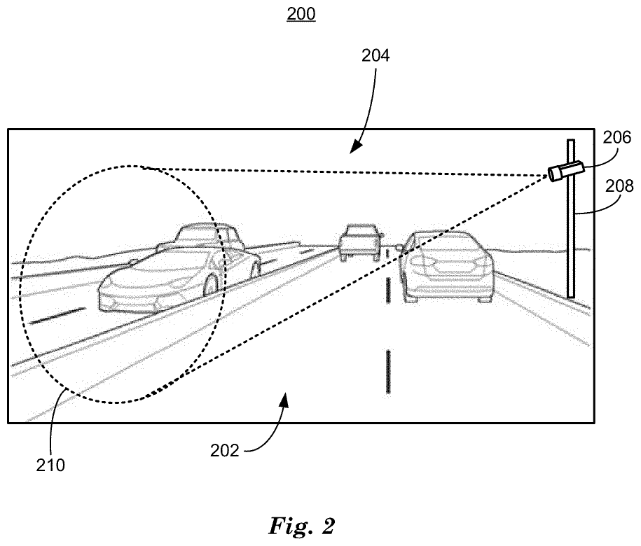

FIG. 2 is a diagram of a traffic scene 200. Traffic scene 200 includes a roadway 202, upon which vehicles 204 operate. Traffic scene 200 also includes a stationary video camera 206. Stationary video camera 206 can be mounted on a pole 208, or other stationary structure, including a building, to afford stationary video camera 206 a field of view 210 that includes a portion of roadway 202 and typically including, from time to time, vehicles 204. Stationary video camera 206 can be attached to pole 208 to permit stationary video camera 206 to maintain a substantially unchanging field of view 210 with respect to roadway 202. Stationary video camera 206 can be calibrated to determine the three-dimensional (3D) location, in global coordinates, of the field of view 210. Global coordinates are positional values based on a global coordinate system such as used by a GPS, such as latitude, longitude and altitude, for example. By determining the 3D location of field of view 210 in global coordinates, the 3D location in global coordinates of a region in a stationary video camera data can be determined, wherein the region corresponds to an object, for example.

A stationary video camera 206 can be calibrated by acquiring a stationary video camera image that includes an object with measured features at a measured location. The sizes of the features can be determined in the stationary video camera image and compared to the sizes of the features in the real world using projective geometry. Projective geometry is a technique for determining real world locations corresponding to locations in an image by measuring real world locations of locations in image data to determine real world locations and sizes of objects in images. The locations features in image data can be transformed into global coordinates based on projection equations based on information regarding measured real world locations, the field of view 208 and the magnification of a lens included in stationary video camera 206 to determine the real world locations of locations in image data in global coordinates.

Stationary video camera 206 can be included in a traffic information system 100. A traffic information system 100 can include server computers 120 configured to acquire stationary video camera data and process it to track objects and locate the tracked objects in global coordinates. Traffic information system 100 can also communicate with a vehicle 110 based on the location of the vehicle 110. For example, a traffic information system 100 can communicate with a vehicle 110 based on its proximity to a stationary video camera 206. The traffic information system 100 can determine information regarding a tracked object that can be out of the fields of view of sensors included in a vehicle 110 but might be viewable by the vehicle 110 in the near future, for example.

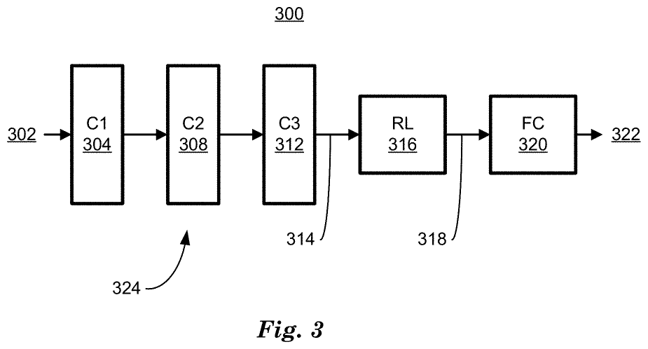

FIG. 3 is a diagram of an example capsule network 300 that can be trained to detect, classify and locate an object in a field of view 210 based on video camera data. A capsule network 300 is a neural network that includes capsule layers C₁ 304 (C1), C₂ 308 (C2), C₃ 312 (C3) and fully connected layers 320 (FC). Capsule network 300 can input video image data 302, wherein video image data includes a frame of video data acquired in a time series of video frames acquired at equal time intervals. Capsule network 300 processes input video image data 302 one video frame at a time. A frame of video image data 302 is input to capsule layers C₁ 304 (C1), C₂ 308 (C2), C₃ 312 (C3), collectively 324, for processing. Capsule network 300 is shown with three capsule layers C₁ 304, C₂ 308, C₃ 312, however a capsule network 300 can have more or fewer capsule layers 324. First capsule layer 304 can process a frame of video data by applying a series of convolutional filters on input data to determine features. Features are output from first capsule layer 304 to succeeding capsule layers 308, 312 to be processed to identify features, group features and measure properties of groups of features by creating capsules including location, size and orientation with respect to a video frame and therefore field of view 210.

Intermediate results 314 output from capsule layers 324 are input to routing layer 316 (RL). Routing layer 316 is used when training a capsule network 300 and passes intermediate results 314 onto fully connected layers 320 at both training and run time for further processing. Routing layer 316 forms routes, or connections between capsule layers 324 based on backpropagation of reward functions determined based on ground truth that is compared to state variables 322 output from fully connected layers 320. Ground truth is state variable information determined independently from state variables 322 output from fully connected layers 320. For example, state variables 322 correspond to detection, classification and location for the tracked object. The same information can be determined by recording location information of the tracked object based on GPS and inertial measurement unit (IMU) sensors included in the tracked object. The recorded location information can be processed to determine ground truth state variables corresponding to location for the object corresponding to the frames of video data input to capsule network 300 as video image data 302.

Computing device 115 can compare state variables 322 output from capsule network 300 and back propagated with ground truth state variables to form a result function while training capsule network 300. The result function is used to select weights or parameters corresponding to filters for capsule layer 324 wherein filter weights that produce positive results as determined by the reward function. Capsule networks perform data aggregation of filter weights by forming routes or connections between capsule layers 324 based on capsules, wherein a capsule is an n-tuple of n data items that includes as one data item a location in the capsule layer 324 and as another data item a reward function corresponding to the location. In the routing layer 316, a for-loop goes through several iterations to dynamically calculate a set of routing coefficients that link lower-layer capsules (i.e., the inputs to the routing layer) to higher-layer capsules (i.e., the outputs of the routing layer). The second intermediate results 318 output from the routing layer 316 is then sent to fully connected layers 320 of the network for further processing. Additional routing layers can exist in the rest of the capsule network 300 as well.

Second intermediate results 318 output by routing layer 316 is input to fully connected layers 320. Fully connected layers can input second intermediate results 318 and output state variables 322 corresponding to target locations. A time series of target locations can correspond to motion of a solid 3D object in a plane parallel to a roadway 202 governed by Newtonian physics. Target tracking includes determining state variables 322 corresponding to a location of the tracked object with respect to a video frame and therefore a field of view 210 of a stationary video camera 206. Capsule network 300 can be trained to detect, classify, and locate objects based on sensor data input from a variety of sensors including radar sensors, lidar sensor, infrared sensors and video sensors. The sensors can be mounted on a variety of stationary or mobile platforms including vehicles 110 and drones, for example.

Object detection can include determining foreground pixels and background pixels in video camera data, where foreground pixels are pixels corresponding to moving objects and background pixels correspond to non-moving regions in video camera data 302, for example. Capsule network 300 can detect an object by determining a connected region of foreground pixels. The detected object can be classified by performing geometric measures on the connected region. For example, a size and shape of a minimally enclosing rectangle can determine to which class a detected object can be assigned. Detected objects can be classified by assigning the detected object to a class corresponding to a vehicle, a pedestrian, or an animal depending upon size and shape. Detected and classified objects can be located by determining a measure like center of mass on the contiguous region of pixels included in the object. Data corresponding to detection, classification, and location of an object in video camera data 302 can be output as state variables 322 by capsule network 300.

Object detection, classification and location data for an object can be used by a computing device for a variety of tasks related to vehicle operation. Object detection, classification and location data from video camera data 302 acquired by a stationary video camera 206 can be downloaded to a vehicle 110 to be used to operate vehicle 110. For example, a vehicle 110 can determine a vehicle path upon which to operate based on a predicted location for an object, where vehicle 110 can detect a collision or near collision between a predicted location of vehicle 110 and a predicted location of an object. Object detection, location and classification data can be acquired from a video camera mounted on a vehicle 110. The vehicle 110 can use the object detection, classification and location data to determine collisions and near-collisions between predicted locations of the vehicle 110 and predicted locations of the object.

Object detection, classification and location data can also be acquired by a video camera mounted on a mobile platform such as a drone. Object detection, classification and location data acquired by a video camera mounted on a drone can be received by a server computer 120 in a traffic information system 100 to determine traffic information. For example, a server computer can determine traffic information like information regarding traffic congestion and traffic accidents based on received object detection, classification, and location and download it to a vehicle 110. Processes that operate vehicles or support vehicle operation based on detecting, classifying and locating objects can benefit by improvements in training capsule networks 300 including fast routing of capsule network 300 disclosed herein by permitting capsule networks 300 to be trained, re-trained, and fine-tuned more efficiently than capsule networks 300 that do not save and restore master routing coefficients as described herein

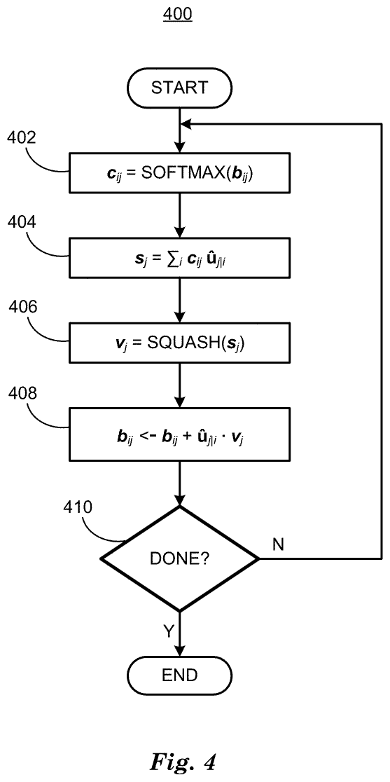

FIG. 4 is a flowchart diagram of a process 400 to determine routing coefficients for a capsule network 300. Process 400 can be implemented by a processor of computing device 115, taking as input information from sensors 116, and executing commands and sending control signals via controllers 112, 113, 114, for example. Process 400 includes multiple blocks taken in the disclosed order. Process 400 could alternatively or additionally include fewer blocks or can include the blocks taken in different orders.

Process 400 begins at block 402, where process 400 takes as input a set of prediction tensors, û_{j|i}, the number of times to perform the routing, r, and the network layer number, l. The prediction tensors û_{j|i} are calculated from the input image. Process 400 includes determining routing coefficients as parent-layer capsule tensors vⱼ for a single input image. Parent-layer capsule tensors vⱼ are defined by equation (2), below, and are used to select a route having a maximal value according to back propagated results. Process 400 is repeated a user input number of times per image for a plurality of input images with corresponding ground truth data when training a capsule network 300. Numbers used herein to describe a size of tensors are examples and can be made larger or smaller without changing the techniques.

Process 400 begins in the block 402 by inputting a single prediction tensor with dimension (16, 1152, 10). The first number, 16, denotes the dimension of a single prediction vector, wherein a single prediction vector is a vector with 16 components wherein each component corresponds to a specific aspect of an object. The second number, 1152, denotes how many capsules i in layer l can be assigned to each of the 10 capsules, j, in layer l+1. Each lower-layer capsule i is responsible for linking a single prediction vector to a parent-layer capsule j. The prediction vectors are learned by the network at training time and correspond to objects as determined by the network given a set of features. The parent-layer capsules j correspond to the object as a whole. Throughout the routing algorithm, the routing coefficients are iteratively calculated to connect lower-layer capsules with the correct higher-layer capsules. With each new image that the network sees, these calculations are performed from scratch between each of the 1152 lower-layer capsules i, and each of the 10 higher-layer capsules j, for each layer l. A tensor bᵢⱼ with dimensions (1152, 10) is initialized to zero and the iteration number k is initialized to 1.

At block 402, a Softmax operation according to equation (1), is applied to a tensor bᵢⱼ with dimensions (1152, 10) to determine routing coefficients cᵢⱼ :

$${c}_{ij} = \frac{exp ( {b}_{ij} )}{{Σ}_{k} exp ( {b}_{ij} )} \qquad ( 1 )$$

The Softmax operation converts the initial values of tensor bᵢⱼ to numbers between 0 and 0.1. The Softmax operation is an example normalization technique used herein, however, other scale-invariant normalization functions can be used advantageously with techniques described herein.

At block 404 the routing coefficients cᵢⱼ are multiplied with each of the prediction vectors and summed to form a matrix Sᵢⱼ =Σᵢcᵢⱼû_{j|i}.

At block 406 the matrix sᵢⱼ is squashed with equation (2) to form output parent-level capsule tensors vⱼ:

$${v}_{j} = \frac{{‖ {s}_{j} ‖}^{2} {s}_{j}}{1 + {‖ {s}_{j} ‖}^{2} ‖ {s}_{j} ‖} \qquad ( 2 )$$

Squashing insures that length of each of the ten rows in sⱼ is constrained to be between zero and one.

At block 408, when the iteration number k is greater than one, the routing coefficients cᵢⱼ of the matrix sᵢⱼ are updated by forming the dot product between the prediction vectors û_{j|i} and the parent layer capsule tensors vⱼ and adding the result to tensor bᵢⱼ. Capsule network 300 can be trained to recognize objects in input images by selecting the row in vⱼ having the longest length, and therefore the highest probability of correctly recognizing the object.

At block 410 process increments the iteration number and compares it to j. If the iteration number is less than or equal to j, process 400 returns to block 402 for another iteration. If the iteration number is greater than j, process 400 ends.

Process 400 is a technique for determining which capsule routes are most likely to correspond to successful operation of capsule network 300, e.g., outputting state variables 322 that match ground truth data. The determined capsule routes can be based on data aggregation, wherein multiple features (capsules) determined by convolutional filtering are combined by routing to correspond to a single object and including information of its detection, classification and location within an image. Fast routing is implemented during inference when the routing of capsule determined in this fashion can be discarded following training, because the routing weights can be saved during training. In use, capsule network 300 can operate based on the saved routing weights and arrive at correct output state variable 322 without individually determining capsule routes as these have been saved during process 400 during training.

Other techniques for determining capsule routes for example expectation-minimization (EM) routing, use dynamic programming to determine optimal sets of capsule routing instead of the technique of process 400. Dynamic programming is a technique for solving a complex problem by breaking it down into a series of smaller steps. The steps can be consecutive, where output from each step forms the input for the next step. Intermediate results between steps can be stored in computing device 115 memory and processed iteratively until predetermined ending conditions are met. For example, amount of change in the final output between successive steps being less that a user determined threshold can be an ending condition.

Routing techniques based on dynamic programming like EM routing are similar to process 400 in that the routing information is discarded following training. Techniques described herein improve capsule network 300 processing by retaining capsule routing information following training in a master routing coefficient matrix that can speed up capsule network 300 inference time, help fine-tune the capsule network 300 after initial training, and help the capsule network 300 train faster. Techniques described herein can decrease processing time exponentially by skipping the for-loop in a dynamic routing algorithm and replacing it with a single tensor multiply operation that can be parallelized across multiple graphics processing units (GPUs) by performing the routing following training, after all the capsule routes have been determined. For example, if the original dynamic routing algorithm uses ten iterations to calculate the routing coefficients, techniques described herein replaces the ten iterations with a single tensor multiply. If the dynamic routing algorithm uses 100 iterations to calculate the routing coefficients, techniques described herein can replace the 100 iterations with a single tensor multiply, and so forth. Techniques described herein can be applied to any capsule network architecture that makes use of routing coefficients to assign object parts to their wholes. In summary, computer processing efficiency, including reducing processing time and/or required processing power, can be greatly increased by the techniques disclosed herein.

Master routing coefficients can be created from individual routing coefficients found during capsule network 300 training corresponding to the capsule network 300 inputs. This single set of master routing coefficients can then be used to make the network faster during inference. The routing coefficients can be determined by first training a capsule network 300 using a training data set and corresponding ground truth data. Routing coefficients can be determined dynamically as discussed above for each training input in the for-loop of process 400, for example. The capsule network 300 can be determined to be trained when a total loss value equal to a difference between state variables 322 and ground truth data is stable. The total loss value is stable when it oscillates about an average value and is no longer increasing or decreasing. The capsule network 300 can be determined to be trained when the total loss value has reached a maximum value.

Routing coefficients can be saved from the routing algorithm for each input at each routing iteration. That is, for each input in a training set, there is a set of routing coefficients that are dynamically calculated in the routing algorithm over r iterations. For process 400, the coefficients for a single input are included in the tensor cᵢⱼ, with dimension (r, 1152, 10), where the numbers 1152 and 10 are for example and can be larger or smaller. For a batch of inputs, cᵢⱼ is a tensor with dimension (N, r, 1152, 10), where N is the number of inputs in the batch. The cᵢⱼ's are the routing coefficients that are saved when evaluating a trained capsule network 300 on the training dataset. The saved routing coefficients can be sorted to differentiate between routing coefficients that correlate highly (typically, >90%) with accurate results and routing coefficients that do not correlate highly with accurate results. The numbers corresponding to the tensor cᵢⱼ elements r, 1152, 10, can vary depending upon the application. The number 10 represents the number of classes handled by the tensor cᵢⱼ and is appropriate for tasks such as vehicle object tracking and hand-written character detection.

The routing coefficients can be all sorted or the routing coefficients can be filtered before sorting. Sorting all of the routing coefficients can produce usable results; however, the amount of time and memory required to perform exhaustive sorting on a full set of routing coefficients, a tensor with dimension (N, r, 1152, 10) can be practically prohibitive. Filtering based on clustering algorithms or similarity measures before sorting can reduce the amount of data and computation significantly. Filtering based on clustering algorithms includes filtering based on known techniques such as EM routing, K-means, or density-based spatial clustering, for example. EM routing can cluster routing coefficients based on assumptions regarding Gaussian distribution of the coefficients. K-means is a statistical technique that can forms groups based on maximizing probabilities. Density-based spatial clustering can maximize joint probabilities based on a Gaussian noise model. What these techniques have in common is that they form groups of clusters of routing coefficients and reduce data by representing the group or cluster by a single routing coefficient. Following filtering by clustering, a set of routing coefficients can be sorted.

Sorting can be performed on routing coefficients by comparing performance of two copies of a capsule network 300, one including weights corresponding to a routing coefficient and another not including weights corresponding to the routing coefficient. The accuracy of the two capsule networks 300 performance on a test data set including images and ground truth can be compared. If the accuracy of the capsule network 300 with the routing coefficient weights is greater than or equal to the capsule network 300 without the routing coefficient weights, the routing coefficients are determined to be “OK” and are retained. If the accuracy of the capsule network 300 with the routing coefficient weights on a test data set including ground truth is worse than the accuracy of the capsule network 300 without the routing coefficient weights, the routing coefficients are determined to be “NOT OK” and are discarded.

Similarity measures can filter routing coefficients by applying a similarity measure such as is known, including a Pearson correlation coefficient, dot product, norm, angle, etc., to the routing coefficients. These measures each determine a metric for routing coefficients that measures a distance between the coefficients and applies it to determine similarity. Similarity measures can determine classes of routing coefficients by selecting groups of coefficients with mutually small distance measures. The classes can be represented by a single representative, thereby achieving data reduction with no loss of accuracy. Following filtering classes can be sorted to discard classes not corresponding to accurate results as discussed above. Following filtering and sorting, a master routing coefficient matrix can be constructed and saved to be used in subsequent processing.

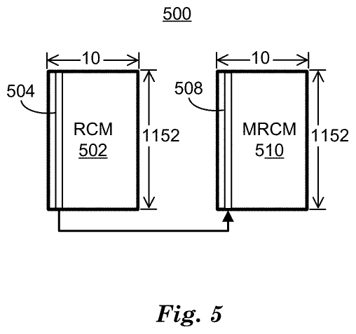

FIG. 5 is a diagram of example routing coefficient matrices 500. Routing coefficient matrices 500 include a routing coefficient matrix 502 (RCM) and a master routing coefficient matrix 510 (MRCM). Tensor cᵢⱼ with dimension (N, r, 1152, 10) from equation (1) and FIG. 4 includes a routing coefficient matrix 502 which is a tensor with dimension (r, 1152, 10) for each input image n in N. Following filtering and sorting as described above, a routing coefficient matrix 502 with dimension (r, 1152, 10) is formed. The number of routing iterations to use for the extraction of the (1152, 10) matrix of routing coefficients can be chosen. The test data and ground truth accuracy of a capsule network 300 including each of the r routing coefficient weights can be determined vs. a copy of the capsule network 300 without any of the r routing coefficient weights. In this fashion, routing coefficients 504 most likely to be accurate can be determined.

Once a routing iteration is selected, the resulting routing coefficient tensor has dimension (1152, 10), with 10 being the number of classes in the dataset, for example. For each training input, the label (i.e., class) of that input can be determined by user input. This label corresponds to one of the 10 columns 504 in the (1152, 10) matrix. That single column 504 is then extracted and put into the corresponding column 508 in an empty (1152, 10) master routing coefficient matrix 510. The empty (1152, 10) master routing coefficient matrix 510 is the master set of routing coefficients. A routing iteration is selected for each training input n in the training set. For repeated labels, the values from the ground-truth column 502 of an individual (1152, 10) coefficient matrix are simply summed with the existing values in the corresponding column 508 in the (1152, 10) master routing coefficient matrix 510.

When the ground-truth column coefficients have been summed for all training inputs, each column in the (1152, 10) master routing coefficient matrix 510 is then normalized by class frequency and a nonlinear function can be applied to the (1152, 10) master routing coefficient matrix 510. This nonlinearity can be determined in the same manner in which the original routing coefficients were dynamically calculated during training. For example, the Softmax function from equation (1) can be applied to each row in the (1152, 10) master routing coefficient matrix 510. After the master routing coefficient matrix 510 is determined, the master routing coefficient matrix 510 can then be replicated N times to conform to the number of inputs per batch used in the capsule network 300, thus, the final dimension of the master coefficient tensor is (N, 1152, 10).

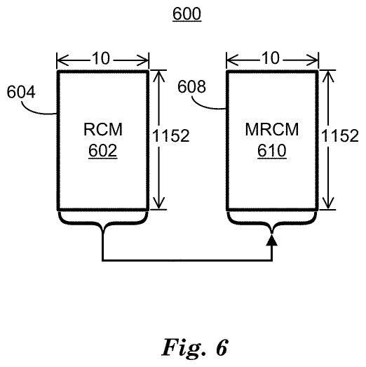

FIG. 6 is a diagram of example routing coefficient matrices 600. Routing coefficient matrices 600 include a routing coefficient matrix 602 (RCM) and a master routing coefficient matrix 610 (MRCM). Tensor cᵢⱼ with dimension (N, r, 1152, 10) from equation (1) and FIG. 4 above includes a routing coefficient matrix 602 is a tensor with dimension (r, 1152, 10) for each input image n in N. Following filtering and sorting as described above, a routing coefficient matrix 602 with dimension (r, 1152, 10) is formed. The process illustrated in FIG. 6 is the same as FIG. 5 except that an entire (1152, 10) routing coefficient matrix 602 is processed for each input n instead of each column 504 of the routing coefficient matrix 502. After the routing coefficients from all of the inputs have been transferred, each column of the master routing coefficient matrix 610 can be normalized by the class frequency for that column.

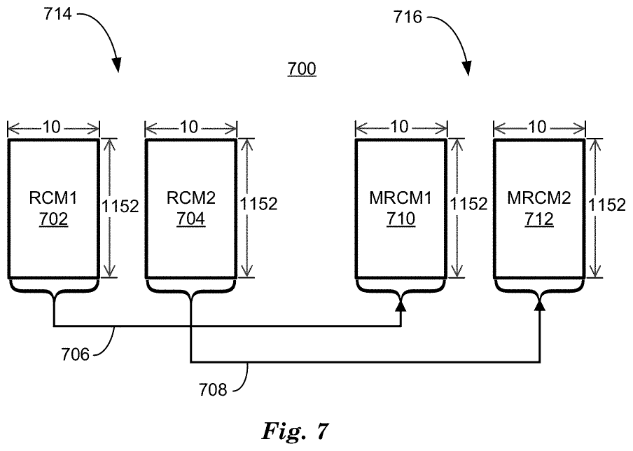

FIG. 7 is a diagram of example routing coefficient matrices 700. Routing coefficient matrices 700 include a first routing coefficient matrix 702 (RCM1), a second routing coefficient matrix 704 (RCM2), a first master routing coefficient matrix 710 (MRCM1) and a second master routing coefficient matrix 712 (MRCM2). Tensor cᵢⱼ with dimension (N, r, 1152, 10) from equation (1) and FIG. 4 above includes a routing coefficient matrix 702, 704 for each class for which a capsule network 300 is trained on. If X is the number of classes of input data upon which a capsule network is trained to recognize, wherein a class is defined as a group of input images for which a capsule network 300 outputs substantially the same result. For each class in X classes, a tensor with dimension (r, 1152, 10) can determined for each input image n in N. Following filtering and sorting as described above, first routing coefficient matrix 702 and second routing coefficient matrix 704 (X=2) are formed.

After X sets of coefficients are created, they can be concatenated into a single master coefficient tensor with dimension (X, 1152, 10) and then replicated N times to conform to the number of inputs per batch used in the capsule network—thus, the final dimension of the master coefficient tensor is (N, X, 1152, 10). When used for fast training the class label of the training input can be used to select which x in X should be applied for each input.

Master routing coefficient tensors can improve the speed of inference of the trained capsule network 300 by removing the for-loop in the routing algorithm. inference.

Master routing coefficient tensors can improve inference of a capsule network 300 by making inference faster. For training, a subset of the full training dataset is first used to train the capsule network i.e., the network is trained using a routing algorithm from FIG. 4, above. Afterwards, the master routing coefficient tensors are extracted as described in relation to FIGS. 5-7. Then, testing is conducted on a second subset of the full training dataset using the master routing coefficients determined based on a first subset of the training data. For a capsule network 300 with an architecture similar to the one shown in FIG. 3, this fine-tunes the part/whole relationship of an object.

Master routing coefficient tensors can improve training of capsule networks 300 by fine-tuning a capsule network 300. Fine-tuning a capsule network 300 refers to the process of training a capsule network 300 with certain layers of the capsule network 300 fixed. For fine-tuning a capsule network 300, the capsule network 300 is trained using a routing algorithm that has a for-loop, using a first subset of the full training dataset. Afterwards, the master routing coefficients are extracted from the training data. Then, fine-tuning is conducted on a second subset of the full training dataset using the master routing coefficients as fixed coefficients (i.e., no for-loop is used in the routing procedure) by re-training the capsule network 300 with the same data and ground truth without determining any new routing coefficients.

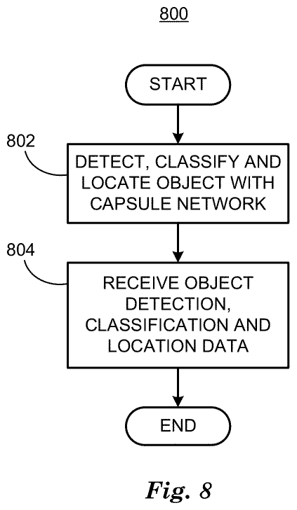

FIG. 8 is a diagram of a flowchart, described in relation to FIGS. 1-7, of a process 800 for determining an object position, tracking an object based on the object position and downloading the object tracking information to a vehicle. Process 800 can be implemented by a processor of server computer 120, taking as input information from sensors, and executing commands, and sending object tracking information to a vehicle 110, for example. Process 800 includes multiple blocks taken in the disclosed order. Process 800 could alternatively or additionally include fewer blocks or can include the blocks taken in different orders.

Process 800 begins at block 802, wherein a server computer 120 acquires a video image from a video camera including a stationary video camera 206 and inputs it to a trained capsule network 300. Capsule network 300 has been trained using master routing coefficient tensors as described above in relation to FIGS. 3-7. Capsule network 300 inputs video image data 302 and can output state variables 322 corresponding to object detection, classification and location data with respect to a video frame. Video camera data can be input from a stationary video camera or a mobile video camera. A mobile video camera can be mounted on a vehicle 110 or a drone, for example.

At block 804, server computer 120 can combine state variable 322 including object detection, classification and location data output from capsule network 300 with ground truth information regarding the location of roadway 202 with respect to field of view 210 of the stationary video camera 206 in global coordinates to transform the state variables 322 into a tracked object location in global coordinates as discussed in relation to FIG. 2, above. A sequence of object locations in global coordinates acquired at equal time intervals is time series data that can be input to a control process that can predict object motion and thereby track the object based on the object locations. Server computer 120 can also download object locations in global coordinates to a vehicle 110 and permit the vehicle 110 to track the object.

In examples where the video camera data is acquired from a mobile platform, object detection, classification and location data can be transformed into global coordinates based on a location and field of view corresponding to a location and field of view of a video camera included in the mobile platform. Because the platform can be moving when the video camera data is acquired, the video camera data can be time stamped to identify a location of the video camera when the video camera data was acquired. Object detection, classification, and location data acquired from mobile platforms can be downloaded to a vehicle 110 directly or received by a server computer 120 to combine with object detection, classification and location data from other sources to determine traffic information. Traffic information can include traffic congestion or traffic accidents, for example. Traffic information can be downloaded to a vehicle 110 to assist vehicle 110 in operating on a roadway 202. Following block 804 process 800 ends.

Computing devices such as those discussed herein generally each include commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., commands), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A method, comprising:
determining a plurality of routing coefficients, each routing coefficient of the plurality of routing coefficients corresponding to routes between capsule layers of a capsule network comprising a neural network;
detecting, classifying, and locating an object by processing video camera data with based on a master set of routing coefficients within the capsule network, wherein training the capsule network includes saving routing coefficients; and
receiving the detected, classified, and located object at a computing device;
wherein the master set of routing coefficients is created from the plurality of routing coefficients.

2. (canceled)

3. The method of claim 1, wherein routing coefficients are determined by grouping routes based on one or more of correlation or clustering following training based on a first training data set, wherein a route connects determined elements in a capsule layer with locations in a subsequent capsule layer.

4. The method of claim 1, wherein routing coefficients are determined by parallel array processing.

5. The method of claim 1, wherein training the capsule network includes retraining the capsule network based on a second training data set and saving routing coefficients.

6. The method of claim 1, further comprising operating a vehicle based on receiving a detected, classified, and located object.

7. The method of claim 6, wherein operating a vehicle based on receiving a detected, classified, and located object includes determining a predicted location of the object in global coordinates.

8. (canceled)

9. The method of claim 1, further comprising acquiring the video camera data with one or more of a stationary video camera included in a traffic infrastructure system and a mobile video camera included in one or more of a vehicle and a drone.

10. A system, comprising a processor; and
a memory, the memory including instructions to be executed by the processor to:
determine a plurality of routing coefficients, each routing coefficient of the plurality of routing coefficients corresponding to routes between capsule layers of a capsule network comprising a neural network;
detect, classify, and locate an object by processing video camera data based on a master set of routing coefficients within the capsule network, wherein training the capsule network includes saving routing coefficients; and
receive the detected, classified, and located object at a computing device,
wherein the master set of routing coefficients is created from the plurality of routing coefficients.

11. (canceled)

12. The system of claim 10, wherein the instructions further include instructions to determine routing coefficients by grouping routes based on one or more of correlation or clustering following training based on a first training data set, wherein a route connects determined elements in a capsule layer with locations in a subsequent capsule layer.

13. The system of claim 10, wherein the instructions further include instructions to determine routing coefficients by parallel array processing.

14. The system of claim 10, wherein the instructions further include instructions to retrain the capsule network based on a second training data set and save routing coefficients.

15. The system of claim 10, further comprising operating a vehicle based on predicting an object location based on receiving a detected, classified, and located object.

16. The system of claim 10, wherein operating a vehicle based on receiving a detected, classified, and located object includes determining a predicted location of the object in global coordinates.

17. The system of claim 10, wherein the instructions further include instructions to determine traffic information based on receiving a detected, classified and located object.

18. The system of claim 10, wherein the instructions further include instructions to acquire the video camera data with one or more of a stationary video camera included in a traffic infrastructure system and a mobile video camera included in one or more of a vehicle and a drone.

19. A system, comprising:
means for controlling vehicle steering, braking and powertrain;
means for determining a plurality of routing coefficients, each routing coefficient of the plurality of routing coefficients corresponding to routes between capsule layers of a capsule network comprising a neural network;
means for detecting, classifying, and locating an object by processing video camera data based on a master set of routing coefficients within the capsule network, wherein training the capsule network includes saving routing coefficients; and
means for receiving the detected, classified, and located object at a computing device; and
operating a vehicle based on the detected, classified, and located object and the means for controlling vehicle steering, braking and powertrain,
wherein the master set of routing coefficients is created from the plurality of routing coefficients.

20. (canceled)

21. The method as recited in claim 1, wherein each routing coefficient is determined based on
$${c}_{ij} = \frac{exp ( {b}_{ij} )}{{Σ}_{k} exp ( {b}_{ij} )} ,$$
where cᵢⱼ represents the routing coefficient, bᵢⱼ represents a tensor, i corresponds to a capsule within the capsule network, and j corresponds to a parent-layer capsule.

22. The system as recited in claim 10, wherein each routing coefficient is determined based on
$${c}_{ij} = \frac{exp ( {b}_{ij} )}{{Σ}_{k} exp ( {b}_{ij} )} ,$$
where cᵢⱼ represents the routing coefficient, bᵢⱼ represents a tensor, I corresponds to a capsule within the capsule network, and j corresponds to a parent-layer capsule.

23. The system as recited in claim 19, wherein each routing coefficient is determined based on
$${c}_{ij} = \frac{exp ( {b}_{ij} )}{{Σ}_{k} exp ( {b}_{ij} )} ,$$
where cᵢⱼ represents the routing coefficient, bᵢⱼ represents a tensor, I corresponds to a capsule within the capsule network, and j corresponds to a parent-layer capsule.

24. The system as recited in claim 10, wherein the instructions further include instructions to train the capsule network using the master set of routing coefficients as fixed layers within the capsule network during a second training iteration.
